(19) United States
(12) Patent Application Publication
(10) Pub. No.: US 2002/0160231 A1
(43) Pub. Date: Oct. 31, 2002

(54) Magnetic layer with high-permeability backing

(76) Inventor: Jon B. Schneider, Marietta, OH (US)

Correspondence Address: FITZPATRICK CELLA HARPER & SCINTO, 30 ROCKEFELLER PLAZA, NEW YORK, NY, 10112, US

(21) Appl. No.: 10/139,680

(22) Filed: May 7, 2002

Related U.S. Application Data
(63) Continuation of application No. 09/435,765, filed on Nov. 8, 1999.

(51) Int. Cl. G11B 5/66

(52) U.S. Cl. 428/694 BM

(57) ABSTRACT

A magnetic article has a magnetic layer having magnetized particles dispersed in a natural or synthetic resin binder and an adjacent high-permeability layer having high-permeability particles dispersed in a natural or synthetic resin binder. The magnetic article may be prepared by co-extruding a mixture of magnetizable particles in a binder and high-permeability particles in a binder through a single die to produce an integral gradient function article having a region of high concentration of magnetizable particles adjacent to one surface of the article and a region of high concentration of the high-permeability particles adjacent to another surface of the article, and magnetizing at least a portion of the magnetizable particles.

### BACKGROUND OF THE INVENTION

1. Field of the Invention

This invention relates to magnetic articles and sheet stock materials that are attracted to iron or other ferromagnetic material and more particularly to such articles and stock materials that incorporate layers of high-permeability magnetic material.

2. Brief Description of the Prior Art

Magnetic signs, cards, decorative objects, holding and supporting magnets, and the like, are commonly used to post information or provide a magnetic field for doing work, such as supporting papers, hooks, and the like, on metal surfaces. Such articles may be sheets or webs of plastic or paper bonded to a magnetic layer for supporting the article on a magnetic attractant surface, e.g., a steel panel. They may comprise a printed layer, e.g., of plastic, paper, cardboard, or the like, bonded to a layer of poled magnetic material. Such magnetic objects may also be in the form of magnetic buttons, or the like, for holding paper or similar objects to metal surfaces. Magnetic materials of this type are also used for supporting hooks, holding cabinet doors in a closed position, and for similar functions where a continued holding force is needed. The magnetic layer typically comprises a mixture of a magnetizable material in particulate form dispersed in a resinous binder. The mixture of particles and binder is formed into a magnetic layer, typically by extrusion of a profile, and a decorative or informative printed sheet is then adhesively bonded to one side of the magnetic layer. The magnetic layer ordinarily is multipoled to provide a magnetic layer having sufficient attraction for a magnetic attractant surface, e.g., a ferrous metal, that the article will adhere to a vertical surface without falling off or sliding down under the force of gravity. Typically the magnetic layer is magnetized with about 4 to about 16 poles per inch.

Because the magnetic fields of the poles are oriented perpendicularly to the major surfaces of the magnetic layer, the lines of magnetic flux extend generally perpendicular to those surfaces. The magnetic flux extending from the surface of the magnetic layer in contact with a ferromagnetic substrate having a low reluctance, e.g., a steel panel forming a wall, or the frame or enclosure of a metal cabinet, will pass easily through the substrate between adjacent north and south poles. However, the magnetic flux extending from the other side of the magnetic layer must pass through essentially empty space (filled only with air) in order to link adjacent poles of opposite magnetic polarity. Because the magnetic permeability of air is relatively low (essentially the same as that of a vacuum), the magnetic circuit including such an air gap has a relatively high reluctance, and the magnetic flux is correspondingly weakened.

U.S. Pat. No. 3,817,356, to Dahlquist, discloses a magnetic sheet material for application to thin panels of steel and the like in order to damp vibrations. The sheet material comprises a layer of flexible magnetic material having a thickness of 10-500 mils, which may be bonded to a backing sheet of steel. The layer of flexible magnetic material comprises a dispersion of magnetic particles in a resin binder. The steel sheet may have a thickness ranging from about 0.5 mils to about 0.25 inches. However, this reference does not disclose magnetic layers thinner than 10 mils, nor a magnetic layer prepared by coating a dispersion of a binder and magnetic particles in a volatile liquid. Furthermore, if the solid metal backing layer is more than a few mils thick, the magnetic sheet material may lack the flexibility that is useful in certain applications. In addition, the presence of a solid metal backing layer requires that the magnetic layer be first formed and then bonded to the backing, or that the magnetic layer be coated, extruded or otherwise immediately deposited onto the backing layer.

Accordingly a need has continued to exist for a magnetic layer having a high-permeability backing layer that is easy to manufacture and can be made flexible.

### SUMMARY OF THE INVENTION

These problems have now been alleviated by the magnetic article of this invention and a process for its preparation. The magnetic article of the invention comprises a layer of magnetizable particles dispersed in a binder integrated to a backing layer comprised of high-permeability particles, e.g., ferromagnetic particles, dispersed in a binder. In another embodiment, the invention comprises a layer of high magnetic permeability, e.g., a sheet of ferromagnetic material or a layer of high-permeability particles dispersed in a binder, having bonded or integrated to each of its major surfaces a magnetic layer comprising magnetizable (e.g., ferrimagnetic) particles dispersed in a binder.

Accordingly, it is an object of the invention to provide a magnetic layer having an enhanced magnetic gauss level.

A further object is to provide a magnetic layer having enhanced magnetic field strength.

A further object is to provide a method for preparing a flexible magnetic sheet material having enhanced magnetic strength.

A further object is to provide a magnetic sheet material having enhanced strength that has a magnetic layer on each side of a high permeability layer.

A further object is to provide a magnetizable article comprised of magnetizable particles dispersed in a binder and high-permeability particles dispersed in a binder, wherein the magnetizable particles and the high-permeability particles are each concentrated in different regions of the article.

A further object is to provide a method for manufacturing a magnetizable article comprised of magnetizable particles dispersed in a binder and high permeability particles dispersed in a binder, wherein the magnetizable particles and the high-permeability particles are each concentrated in different regions of the article.

A further object is to provide a magnetizable or magnetic stock material from which magnetic articles can be formed.

Further objects of the invention will become apparent from the description of the invention that follows.

### BRIEF DESCRIPTION OF THE DRAWINGS

FIG. 1A illustrates a cross section of a magnetic article of this invention having a magnetic layer comprised of magnetizable particles and a high-permeability layer comprised of high-permeability particles dispersed in a binder.

FIG. 1B illustrates a cross section of a magnetic article of this invention having an integral layer with gradient functionality comprising a binder containing magnetizable particles, concentrated near one surface of the layer, and high-permeability particles, concentrated near the opposite surface.

FIG. 2A illustrates an embodiment of the invention incorporating a magnetic layer, comprised of magnetizable particles dispersed in a binder, a backing layer comprising high-permeability particles dispersed in a binder, and a substrate or display layer.

FIG. 2B illustrates a cross section of a magnetic article of the invention having an integral layer with gradient functionality comprising a binder containing magnetizable particles, concentrated near one surface of the layer, and high-permeability particles, concentrated toward the opposite surface, and a substrate or display layer.

FIG. 3A illustrates an embodiment of the invention having magnetic layers comprised of magnetizable particles dispersed in a binder disposed on both major surfaces of a high-permeability layer comprised of high-permeability particles dispersed in a binder.

FIG. 3B illustrates a cross section of a magnetic article of this invention having an integral layer with gradient functionality comprising magnetizable particles and high-permeability particles, wherein the magnetizable particles are concentrated near both major surfaces of the layer, and the high-permeability particles are concentrated toward a plane generally midway between the major surfaces.

FIG. 4 illustrates an embodiment of the invention having magnetic layers, comprised of magnetizable particles dispersed in a binder, disposed on both major surfaces of a high permeability layer comprised of high-permeability material.

### DETAILED DESCRIPTION OF THE INVENTION AND PREFERRED EMBODIMENTS

According to the invention the magnetic force exerted by a self-supporting magnetic article comprising magnetic particles dispersed in a binder is increased by providing an adjacent layer of high-permeability particles dispersed in a binding matrix. The layer of high-permeability particles is located opposite to the surface of the magnetic article that contacts a ferromagnetic metallic support surface. The layer of high-permeability particles provides a low-reluctance path for the magnetic field, whereby the strength of the field, i.e., gauss level, is increased and the magnetic attractive force is correspondingly increased. The high-permeability particles may be particles of any material having a magnetic permeability greater than that of air. It is preferred that the high-permeability particles be made of a ferromagnetic material, e.g., particles of a ferromagnetic metal or alloy or a magnetically soft ferrite, and have low magnetic coercivity. Suitable materials for the high-permeability particles include soft iron and Fe₃P. Typically, the layer of high-permeability particles will comprise from about 40% by weight to about 92% by weight of ferromagnetic particles and from about 8% by weight to about 60% by weight of binder. The binder for the layer of high-permeability particles may be any conventional natural or synthetic resin binder suitable for use in the manufacture of flexible particulate magnetic layers. The layer of high-permeability particles may be prepared by any conventional procedure used to prepare the layer of magnetic particles, as discussed more fully below.

The high-permeability layer will provide a low-reluctance path for the magnetic flux exiting the face of the magnetic layer, i.e., a path that has a magnetic reluctance lower than a corresponding path through air. The magnetic permeability of the high-permeability layer will be determined by the permeability of the particles themselves and the density of the particles within the binding matrix. The average permeability of the high-permeability layer will typically range from a value of about 2 to a value of several hundreds. However, any increase in the average permeability over that of an air-filled path is beneficial, and any layer having an average permeability greater than that of air is considered to be a high-permeability layer according to the invention.

The thickness of the high-permeability backing layer may vary from about 0.1 mil to about 500 mils.

The magnetic layer that is bonded or integrated to the high-permeability backing layer may be any conventional flexible magnetic layer. Such layers typically comprise a dispersion of magnetizable particles in a natural or synthetic resin binder. The layers are manufactured by dispersing the magnetic particles in an uncured or unhardened state of the resin binder, then forming the mixture into a sheet, or other appropriate shape for a magnetic article, and curing or hardening the binder. For example, the magnetic particles may be dispersed in an uncured rubber or plasticized resin in a high-shear mixer, and the mixture may then be extruded, usually at elevated temperature, through a suitably shaped die or nozzle to form a sheet material. The sheet may be used as extruded, i.e., uncured, or may be cured by incorporating a curing or vulcanizing agent into the mixture or by cooling to about room temperature. When prepared by extrusion, calendering or the like, the magnetic layer may have a thickness of from about 0.01 inch to about 1 inch (about 250 micrometers to about 2.54 centimeters).

It is also possible to prepare the magnetic layer by forming a dispersion of a particulate magnetic material and a resin binder therefor in a volatile vehicle. The dispersion may then be coated onto a substrate to a desired thickness, and the volatile vehicle evaporated leaving a layer comprising the particulate magnetic material dispersed in the resin binder.

After formation of the layer of magnetic particles in a resin binder, the layer is magnetized by conventional procedures, e.g., by passing the layer over a multipole magnetizer.

The magnetic layer will typically comprise from about 40% to about 92% by weight of a magnetizable particulate material and about 8% to about 60% of a binder.

When the magnetic layer is prepared by coating from a volatile solvent solution or dispersion, the layer is generally relatively thin, i.e., to provide a dried solid layer of magnetic material of a thickness ranging from about 1 mil (25 μm) to about 120 mils (3 mm), preferably from about 1 mil (25 μm) to about 20 mils (500 μm), and more preferably from about 5 mils (125 μm) to about 20 mils (500 μm).

If the magnetic layer is prepared by coating a dispersion of magnetic particles and resin binder in a volatile solvent, any conventional coating procedure can be used to deposit the coating dispersion onto the substrate. Thus, roll coating, gravure coating, doctor blade coating, extrusion, and the like can be used to deposit the dispersion or slurry onto the substrate. A preferred method of coating is to deposit the slurry onto a web substrate and immediately pass the coated substrate over a roll having a doctor blade spaced from the roll to control the thickness of the deposit. The dispersion of magnetic particles and binder can also be deposited onto the substrate by printing. The magnetic layer need not be continuous on the substrate, but can be deposited in a pattern, e.g., dots of magnetic material distributed over the substrate.

The volatile liquid vehicle in which the binder and magnetic particles are suspended for coating may be any such liquid vehicle that is compatible with a particular binder. Thus for binders that are dispersible in water, such as acrylic latices, water is a suitable vehicle. For binders that are not dispersible in water, e.g., rubber, or the like, a volatile organic solvent can be used to disperse or dissolve the binder for coating. Such coating vehicles and their use with particular binders are conventional and known to those skilled in the art. It is preferred to use water as the volatile liquid vehicle, and to use a binder that can be dispersed in water.

If the solvent-coated magnetic layer is deposited onto a substrate, the substrate will be chosen according to the final use of the magnetic article. For example, the substrate may be a plastic web having a smooth surface that accepts marks from special markers that are easily wiped off. The substrate may be a preprinted paper or plastic web provided with text, photographs, or decorative artwork or may be a thin web to which a printed paper or plastic web is fastened with adhesive. The substrate may be have a release surface, e.g., a glass surface or synthetic resin web treated with a release agent, e.g., a silicone material, to prevent the binder from forming a permanent bond with the substrate. After the magnetic layer has dried, it can be transferred to another surface either directly or after being stripped from the release layer. If the binder of the magnetic layer is a pressure-sensitive binder the magnetic layer can be directly adhered to another surface by pressure. The magnetic layer may also be softened by contact with a solvent for the binder and transferred by pressure to another surface. The separately prepared magnetic layer can also be adhered to another surface by an intermediate layer of adhesive. The substrate for such solvent coated magnetic layers and high-permeability layers will typically be a thin and often flexible web material, suitable for providing a surface that can carry printing or the like. Such a substrate should be a lightweight material preferably having a weight not exceeding about 10 pounds per square foot (4.88 g/cm²). The substrate for use with magnetic layers prepared by extrusion of a mixture of magnetic particles in a binder may be significantly heavier if necessary, i.e., having a weight of up to several tens of pounds per square foot.

When the magnetic layer is prepared by coating a mixture of magnetizable particles and a binder in a volatile solvent, the coated layer is dried by evaporating the volatile liquid vehicle to deposit the dispersion of resin and magnetic particles on the substrate as a solid layer. The volatile liquid vehicle can be removed by natural evaporation, by simply exposing the coated layer to a dry atmosphere. Alternatively, the evaporation can be aided and accelerated by heating the coated layer in an oven or by radiant or convective heat, or the like.

The dried, coated layer of magnetic particulate material dispersed in the resin binder is then magnetized, preferably with a conventional multipole magnetizer, to provide a multipoled magnetic layer. The magnetic layer should be coated to a sufficient thickness that the magnetic poling at practical levels of magnetization will provide sufficient magnetic attraction to a magnetically attractive surface, e.g., a ferromagnetic metal surface, to support the magnetic layer and the substrate on which it is coated. Ordinarily the poles are spaced at a distance in the range of from about 0.5 poles per inch to about 20 poles per inch (about 1 pole per 5.1 centimeters to about 8 poles per centimeter). Typically, magnetic layer prepared by coating from a dispersion in a volatile solvent will provide an attractive force of up to about 10 pounds per square foot (4.88 g/cm²). Magnetic layers prepared by extrusion of a mixture of magnetic particles and a binder may provide any amount of attractive force that is conventional in the art, e.g. up to several tens of pounds per square foot.

The particulate magnetic material used in the magnetic layer of the invention may be any material that can be incorporated into the magnetic coating in sufficient amount and permanently magnetized to a sufficient magnetic strength to achieve a magnetic layer that is self-adherent to a magnetic attractant surface. Suitable particulate magnetic materials include any magnetizable magnetic particles conventionally used in flexible magnetic layers. Accordingly, magnetic particles having a high magnetization and high coercivity, such as strontium and barium ferrites, alloys with a base of aluminum, nickel, and cobalt (ALNICO), rare earth magnetic materials, such as those incorporating neodymium, iron, boron and the like, can be used. It is preferred to use particles of strontium ferrite.

Suitable extrudable resin binders include natural and synthetic rubbers, poly(vinyl chloride), plastisols e.g., poly(vinyl chloride) plastisols, polyethylene, chlorinated polyethylene, chlorosulfonated polyethylene, polypropylene, polyisobutylene, styrene-butadiene resins, and mixtures thereof, and the like. Suitable coatable resin binders include any natural or synthetic resin that is dispersible in a volatile liquid vehicle used in the process of the invention. Preferred binders include synthetic water-dispersible resins, such as vinyl acetate, copolymers of vinyl chloride and vinyl acetate, ethylene-vinyl acetate copolymers, polyvinyl butyral, styrene-maleic acid resins and modified styrene-maleic acid resins, acrylic latices such as ethyl acrylate or acrylate-methacrylate copolymer latices, polyolefins, and the like. Resins soluble in volatile organic solvents can also be used in the process of the invention, although they are less preferred because volatile organic solvents are subject to significant environmental restrictions.

The high permeability backing layer and the magnetic layer can be prepared separately and bonded or integrated together after they are formed. They may be bonded or integrated before or after the magnetic layer has been magnetized. The layers can be bonded or integrated with a thin layer of adhesive, or by heating the layers to soften them and bonding or fusing them by subjecting the assembled layers to pressure, as by passing the assembly through nip rolls or the like. The article of the invention may also be prepared by extruding separate layers of magnetizable particles and high-permeability particles, each dispersed in an appropriate binder, through adjacent extrusion nozzles and immediately thereafter bonding the layers together with pressure before they have completely cooled or cured.

It is preferred to prepare the assembly of magnetic layer and high-permeability backing layer by preparing extrudible mixtures of high-permeability particles and magnetizable particles, respectively, in appropriate binders, typically in the same binder material, and then coextruding the materials through a single die or nozzle to form an extruded profile. The supply of the two mixtures to the die is arranged so that the magnetizable particles are concentrated toward one surface of the extruded profile while the high-permeability particles tend to be concentrated toward another surface, ordinarily the opposite surface. Such co-extrusion of articles having a gradation of properties by arranging the feeding of the extrudible material to the die is conventional and known to those skilled in the art. As a result, the extruded article exhibits a region of preferential concentration, i.e., relatively high concentration, of magnetic particles near one surface and a region of preferential concentration of high-permeability particles near another, usually the opposite, surface, where the concentration of the particles is defined as the number of particles per unit volume. In the region between the opposite surfaces the two types of particles may be somewhat intermixed to provide a gradient of density of the particles between the region of concentrated magnetic particles and the region of concentrated high-permeability particles. Although the gradient will ordinarily be mutual, it is not excluded that the gradient of particle density will be confined to the region containing magnetizable particles or the region containing high-permeability particles. In this way, the initial mixtures of magnetizable magnetic particles and high-permeability particles in separate batches of extrudible binders become integrated by fusion of the binders into a single layer having a gradient functionality. Such intimate bonding permits dispensing with an adhesive layer, which would insert a gap of low permeability and relatively high reluctance between the magnetic layer and the high-permeability backing layer. Accordingly, the manufactured article is an integrated article having a region of preferential concentration, of magnetizable particles adjacent to one surface and another region of preferential concentration of high-permeability particles adjacent to another surface with a gradient of concentration of either or both of the magnetizable particles and the high-permeability particles between the regions. The gradient of concentration of the particles may be made relatively gradual, with a relatively thick region of varying concentration of one or both types of particles between the regions of preferential concentration, or relatively steep or sharp, with a narrow, region of varying concentration between the regions of preferential concentration. Even a sharp transition between the two regions of preferential concentration is possible. The degree to which the functionality of the article is gradated may vary with the particular use to which the article is to be put in order to the achieve the optimum result in each case, e.g., high holding force, ease of removal from an attractant surface, and the like. The degree of gradation for obtaining optimum results in a given application can be determined by the practitioner with routine experimentation.

Magnetizable articles of the invention may be prepared by extruding a profile of appropriate cross-section and severing the profile into lengths to form finished articles. Alternatively, a sheet of stock material having adjacent fused layers of magnetizable particles and high-permeability particles may be extruded, and later cut into magnetic articles by conventional methods such as shearing, die-cutting, and the like. The magnetizable extruded or otherwise prepared profile or stock material of the invention can be magnetized either before or after it is cut into the final commercial articles. The magnetization process using a multipole magnetizer is conventional. Typically the poles are spaced at a distance in the range of from about 0.5 poles per inch to about 20 poles per inch (about 1 pole per 5.1 centimeters to about 8 poles per centimeter).

The assembly of magnetic layer and high-permeability backing layer (or integrated layer having gradient functionality) can be bonded to a substrate layer of the type described above. Such a layer may be adhered to the backing layer to provide additional strength to the assembly, to provide a surface for displaying printed indicia, or to provide a surface for writing, as is conventional in the art.

In an alternate embodiment of the invention a high-permeability layer may be positioned between two magnetic layers. Such an assembly can be affixed to a magnetic substrate, e.g., a metal panel, by means of one of the magnetic layers. The other magnetic layer then presents a magnetized external surface to which magnetic materials, such a metal objects, and the like, can be mounted. The presence of two separate magnetic layers permits each layer to be poled with a different pole spacing, as may be optimal for its intended use.

Although it is preferred that the central high-permeable layer in this embodiment be a layer of ferromagnetic particles dispersed in a binder, it is also possible to use a layer of a solid ferromagnetic metal, such as a sheet of steel, mu-metal or the like. In a preferred embodiment the of the dual-sided magnetic article of the invention, the magnetizable magnetic particles and the high-permeability particles are mixed with appropriate extrudible binders, which may be the same for both types of particles, and coextruded as described above. The feed of the extrudible mixtures to the extruder is arranged to provide a single gradient-function extruded profile having magnetized particles concentrated toward opposite surfaces and the high-permeability particles concentrated in the interior region of the article. Such a profile accordingly has regions of preferential concentration of magnetic particles adjacent two surfaces of the profile and a third region of preferential concentration of high-permeability particles located generally between the other two regions. The gradient of concentration of the particles between the regions of preferential concentration of magnetic particles and high-permeability particles for the integral layer having more than two regions of preferential concentration may be selected for optimum results in a given application, as discussed above for the embodiment of the invention having an integral layer with two regions of preferential concentration of particles.

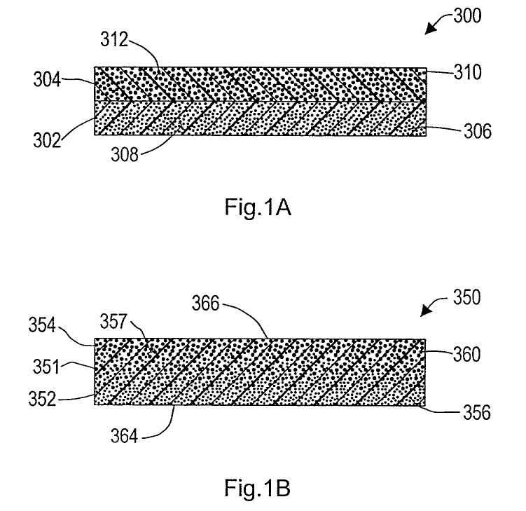

FIG. 1A illustrates a cross-section of a magnetic article 300 of the invention in the form of a sheet comprising a magnetic layer 302 and a high-permeability backing layer 304. The magnetic layer 302 comprises magnetizable particles 306, e.g., ferrite particles, dispersed in a binder 308. The high-permeability backing layer 304 comprises high-permeability (e.g., ferromagnetic) particles 310 dispersed in a binder 312. The binder used in the magnetizable layer may be the same as or different from that used in the high-permeability layer.

FIG. 1B illustrates a magnetic article 350 of the invention comprising a single layer 351 having a gradient functionality. Magnetizable particles 356, e.g., ferrite A particles, and high-permeability particles 360 are dispersed in a binder 357. The magnetizable particles 356, e.g., ferrite 45 particles, are concentrated in a magnetic region 352 near the lower surface 364, and the high-permeability particles 360 are concentrated in a high-permeability region 354 near the top surface 366 of the article 350. This embodiment of the invention exhibits a mutual gradient of density of the magnetizable particles 356 and high-permeability particles 360 between the magnetic region 352 and the high-permeability region 354, to provide a gradient functionality to the magnetic article 350.

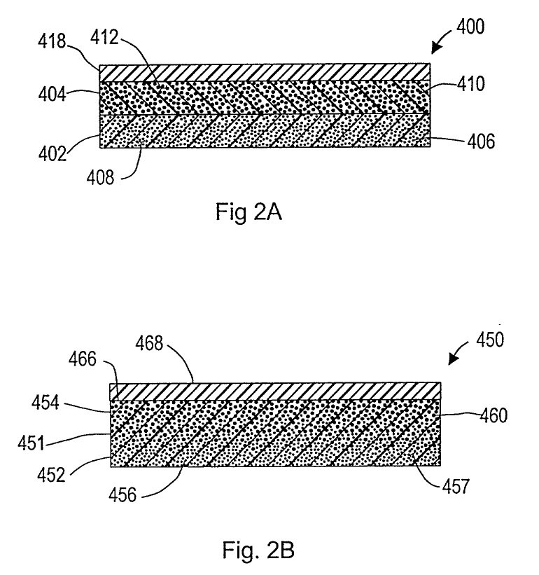

FIG. 2A illustrates a magnetic sheet article 400 which comprises a magnetic layer 402 of magnetizable particles 406 dispersed in a binder 408, a high-permeability layer 404 of high-permeability particles 410 dispersed in a binder 412, and a substrate layer 418 adjacent to the high-permeability layer 404. The substrate layer 418 can be a synthetic resin web, such as polyethylene terephthalate, polyvinyl chloride, or the like, a nonwoven material such as paper, cardboard, or the like, or a woven web of cloth, or the like, as discussed above.

FIG. 2B illustrates a magnetic sheet article 450, which comprises a single layer 451 having a gradient functionality, and a substrate layer 468. Magnetizable particles 456, e.g., ferrite particles, and high-permeability particles 460 are dispersed in a binder 457. The magnetizable particles 456, are concentrated in a magnetic region 452 near the lower surface 464, and the high-permeability particles 460 are concentrated in a high-permeability region 454 near the top surface 466 of the single layer 451. There is a mutual gradient of density of the magnetizable particles 456 and high-permeability particles 460 between the magnetic region 452 and the high-permeability region 454, to provide a gradient functionality to the magnetic article 450. A substrate layer 468 is bonded to the upper surface 466 of the layer 451. The substrate layer 468 can be made of the same materials as in FIG. 2A.

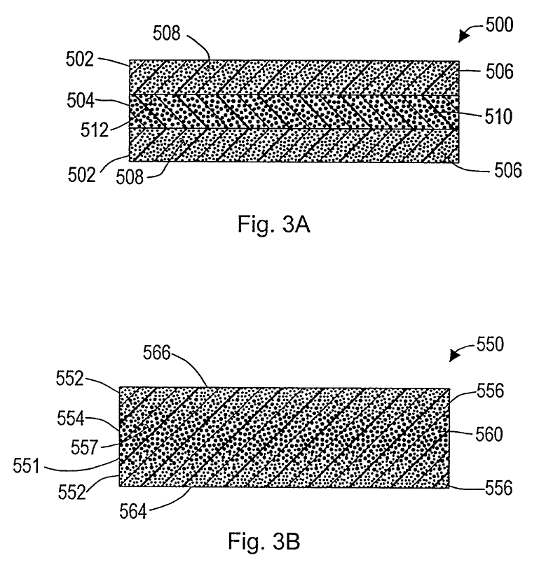

FIG. 3A illustrates a cross-section of a magnetic article 500 of the invention having magnetic layers 502 positioned on both major surfaces of high-permeability layer 504. The magnetic layers 502 are comprised of magnetic particles 506 dispersed in a binder 508. The high-permeability layer 504 is comprised of ferromagnetic particles 510 dispersed in a binder 512.

FIG. 3B illustrates a cross section of a magnetic article or layer 550 of the invention comprising a single layer 551 having a gradient functionality. Magnetizable particles 556, e.g., ferrite particles, and high-permeability particles 560 are dispersed in a binder 557. The magnetizable particles 556, are concentrated in magnetic regions 552 near the lower surface 564 and upper surface 566 of the layer 551. The high-permeability particles 560 are concentrated in a high-permeability region 554 centrally positioned between the magnetic regions 552. There is a mutual gradient of density of the magnetizable particles 556 and high-permeability particles 560 between the magnetic regions 552 and the high-permeability region 554, to provide a gradient functionality to the magnetic article 550.

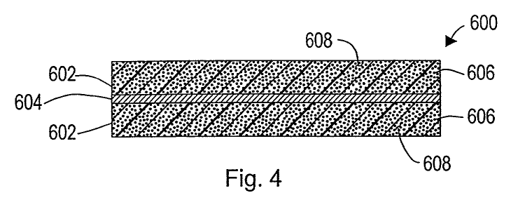

FIG. 4 illustrates a magnetic sheet 600 of the invention having magnetic layers 602 positioned on both major surfaces of high-permeability metal layer 604. The magnetic layers 602 are comprised of magnetizable particles 606 dispersed in a binder 608. The high-permeability layer 604 is made from a metal having a magnetic permeability greater than that of air. Preferably, the high-permeability layer 604 is made from a metal having a relatively high magnetic permeability, such as steel, soft iron, mu-metal or the like.

The magnetic articles of the invention have a number of advantages. The integrated structure generally provides stronger magnetic holding power than conventional magnets prepared from dispersions of ferrite particles in a binding matrix. The articles and stock material prepared using the integrated magnetic structure of the invention, incorporating gradient functionality, may be easily prepared in many shapes, sizes and thicknesses. They allow the manufacture of magnetic articles that are well adapted to consumer use because they have enhanced strength and can be prepared in forms that are easily handled and devoid of hard and sharp corners or projections such as are frequently found on solid metallic and hard ceramic magnets of similar magnetic strength. Accordingly, they are readily adapted for use in household products, toys, and the like. The coextrusion method of the invention allows for economic manufacture of magnets of this type.

The invention will be illustrated by the following example which is intended to illustrative only and non-limiting.

### EXAMPLE

This example compares the pull strength of magnets prepared according to the invention with that of conventional magnets.

A first curable mixture of the type used in preparing flexible magnetic materials was prepared by thoroughly mixing a conventional strontium ferrite powder (“Hoosier UHE13”) having a particle size of about 2 micrometers with a conventional curable binder. The mixture comprised about 10% by weight of the magnetic particles and about 90% by weight of the binder. The mixture was then used to prepare calendered flexible magnetic sheet material in thicknesses of 22 mils, 32 mils, and 68 mils. These sheets served as controls and as base material for fabrication of magnets according to the invention. A second similar mixture was prepared comprising about 5% by weight of a high permeability powder of reduced atomized iron (manufactured by Pyron Corporation, Niagara Falls, N.Y., part No. 2068) and about 95% by weight of the same curable binder used for the magnetic sheet material. This mixture was used to prepare a high-permeability calendered sheet having a thickness of 10 mils (254 micrometers).

Three test samples were prepared by fusing layers of the high permeability sheet to the three thicknesses of magnetic sheet material.

The test samples and the three control sheets were magnetized with a conventional magnetizing apparatus having 5 poles per inch. Test magnets were cut from the sample and control sheets having dimensions of 2 inches by 2 inches. In order to test the strength of the magnets, the surface of a sample magnet having the high-permeability particles adjacent thereto was adhesively fastened to a nonmetallic plate and the surface having the magnetized ferrite particles adjacent thereto was applied to a flat mild steel plate of 0.5 inch thickness. The two plates were pulled apart in a conventional strength testing apparatus (Instron® tensile strength testing machine) containing a load cell that recorded the force exerted by the testing apparatus. When the force reached a certain value the magnet detached from the steel plate. The force required to separate the test magnet from the steel surface is converted into standard units of pounds per square foot, and is termed the “pull strength” of the magnetic material. The pull strength for magnetic materials according to the invention of three different thicknesses is compared with the pull strength of comparable test materials in Table 1 below.

TABLE 1
Pull Strength of Magnetic Sheet Material With and Without
High-Permeability Particulate Backing Layer

| | Overall | Magnet without | Magnet with |
|---|---|---|---|
| Sample | Thickness | Backing Layer | Backing Layer |
| No. | (mils) | (lbs/ft²) | (lbs/ft²) |
| 1 | 33 | 66 | 128 |
| 2 | 42 | 70 | 145 |
| 3 | 78 | 84 | 120 |

The data in Table 1 show that the incorporation of the layer of high-permeability particles into a flexible magnetic layer can increase the pull strength of the magnetic material. The magnets so constructed are also more economical because some of the expensive ferrite particles can be replaced by less costly high-permeability particles.

The invention having now been fully described, it should be understood that it may be embodied in other specific forms or variations without departing from its spirit or essential characteristics. Accordingly, the embodiments described above are to be considered in all respects as illustrative and not restrictive, the scope of the invention being indicated by the appended claims rather than the foregoing description, and all changes which come within the meaning and range of equivalency of the claims are intended to be embraced therein.

We claim:

1. A self-supporting magnetic article comprising
a magnetic layer comprising magnetizable particles dispersed in a natural or synthetic resin binder and having magnetic poles impressed thereupon spaced apart at a spacing in a range of from about 0.5 to about 20 poles per inch, and
a high-permeability layer integrated with said magnetic layer, said high-permeability layer comprising high-permeability particles dispersed in a natural or synthetic resin binder.

2. The magnetic article of claim 1 wherein said magnetic layer has a thickness in a range from about 1 mil to about 1 inch.

3. The magnetic article of claim 1 wherein said magnetizable particles are selected from the group consisting of strontium and barium ferrites, alloys of aluminum, nickel, and cobalt, and rare earth magnetic materials.

4. The magnetic article of claim 1 wherein said magnetizable particles are ferrite particles.

5. The magnetic article of claim 4 wherein said ferrite is selected from the group consisting of barium ferrite and strontium ferrite.

6. The magnetic article of claim 5 wherein said ferrite is strontium ferrite.

7. The magnetic article of claim 3 wherein said rare earth magnetic material is an alloy of neodymium, iron, and boron.

8. The magnetic article of claim 1 wherein said high-permeability particles are particles of a metal having a magnetic permeability greater than that of air.

9. The magnetic article of claim 1 wherein said high-permeability particles are particles of Fe₃P.

10. The magnetic article of claim 1 wherein said high-permeability particles are particles of soft iron.

11. The magnetic article of claim 1 additionally comprising a substrate layer adjacent to said high-permeability layer.

12. The magnetic article of claim 11 wherein said substrate layer is comprised of a synthetic resin web.

13. The magnetic article of claim 11 wherein said substrate layer is comprised of paper.

14. The magnetic article of claim 11 wherein said substrate layer is comprised of cardboard.

15. The magnetic sheet of claim 11 wherein said substrate is preprinted.

16. The magnetic article of claim 1 wherein said binder is a natural or synthetic resin.

17. The magnetic article of claim 1 wherein said binder is selected from the group consisting of vinyl acetate, copolymers of vinyl chloride and vinyl acetate, ethylene-vinyl acetate copolymers, polyvinyl butyral, styrene-maleic acid resins and modified styrene-maleic acid resins, and acrylic resins.

18. The magnetic article of claim 1 wherein said binder is selected from the group consisting of polyethylene, chlorinated polyethylene, chlorosulfonated polyethylene, polypropylene, poly(vinyl chloride), and polyisobutylene.

19. A method of preparing a magnetizable article comprising
1) preparing a first dispersion of magnetizable particles in a first extrudible binder;
2) preparing a second dispersion of high-permeability particles in a second extrudible binder, said high-permeability particles having a magnetic permeability greater than that of air;
3) coextruding said dispersion of magnetizable magnetic particles and said dispersion of high-permeability particles to form an integrated article having a first region of preferential concentration of said magnetizable particles adjacent to one surface of said article and a second region of preferential concentration of said high-permeability particles adjacent to another surface of said article with a gradient of concentration of at least one of said magnetizable particles and said high-permeability particles between said first and second regions.

20. The method of claim 19 comprising the additional step of magnetizing at least a portion of said magnetizable particles.

21. A magnetizable article produced by the process of claim 19.

22. A magnetized article produced by the process of claim 20.

23. A method of preparing a magnetizable article comprising
1) preparing a first dispersion of magnetizable magnetic particles in a first extrudible binder;
2) preparing a second dispersion of high-permeability particles in a second extrudible binder, said high-permeability particles having a magnetic permeability greater than that of air;
3) extruding said dispersion of magnetizable magnetic particles and said dispersion of high-permeability particles to form adjacent layers of said magnetizable particles dispersed in said first binder and said high-permeability particles dispersed in said second binder; and
4) fusing adjacent surfaces of said adjacent layers to form an integral layer.

24. The method of claim 23 comprising the additional step of magnetizing at least a portion of said magnetizable particles.

25. A magnetizable article produced by the process of claim 23.

26. A magnetized article produced by the process of claim 24.

27. A method of preparing a magnetizable article comprising
1) preparing a first dispersion of magnetizable magnetic particles in a first extrudible binder;
2) preparing a second dispersion of high-permeability particles in a second extrudible binder, said high-permeability particles having a magnetic permeability greater than that of air;
3) extruding said dispersion of magnetizable magnetic particles and said dispersion of high-permeability particles to form a first layer of said magnetizable particles dispersed in said first binder and a second layer of said high-permeability particles dispersed in said second binder;
4) contacting a surface of said first layer with a surface of said second layer, and
5) fusing said contacted surfaces to form an integral layer.

27. The method of claim 26 comprising the additional step of magnetizing at least a portion of said magnetizable particles in said magnetizable article.

28. A magnetizable article produced by the process of claim 26.

29. A magnetized article produced by the process of claim 27.

30. A method of preparing a magnetizable article comprising
1) preparing a first dispersion of magnetizable magnetic particles in a first extrudible binder;
2) preparing a second dispersion of high-permeability particles in a second extrudible binder, said high-permeability particles having a magnetic permeability greater than that of air;
3) extruding said dispersion of magnetizable magnetic particles and said dispersion of high-permeability particles to form a first layer of said magnetizable particles dispersed in said first binder and a second layer of said high-permeability particles dispersed in said second binder; and
4) adhesively bonding a surface of said first layer with a surface of said second layer.

31. The method of claim 30 comprising the additional step of magnetizing at least a portion of said magnetizable particles in said magnetizable article.

32. A magnetizable article produced by the process of claim 30.

33. A magnetized article produced by the process of claim 31.

34. A method of preparing a magnetizable article comprising
1) preparing a first dispersion of magnetizable magnetic particles in a first binder;
2) preparing a second dispersion of high-permeability particles in a second binder, said high-permeability particles having a magnetic permeability greater than that of air;
3) forming said dispersion of magnetizable magnetic particles into a first layer of said magnetizable particles dispersed in said first binder
4) forming and said dispersion of high-permeability particles into a second layer of said high-permeability particles dispersed in said second binder; and
5) bonding a surface of said first layer to a surface of said second layer.

35. The method of claim 34 comprising the additional step of magnetizing at least a portion of said magnetizable particles in said magnetizable article.

36. A magnetizable article produced by the process of claim 34.

37. A magnetized article produced by the process of claim 35.

38. A self-supporting magnetic article comprising
a body having a first magnetic surface and a second opposed magnetic surface,
said body having a first region adjacent to said first magnetic surface containing magnetizable particles dispersed in a natural or synthetic resin binder,
a second region adjacent to said second magnetic surface containing magnetizable particles dispersed in a natural or synthetic resin binder, and
a third region between said first region and said second region, said third region containing high-permeability particles dispersed in a natural or synthetic resin binder.

39. The magnetic article of claim 38 wherein
said first region comprises a first layer of magnetizable particles dispersed in a natural or synthetic resin binder,
said second region comprises a second layer of magnetizable particles dispersed in a natural or synthetic resin binder, and
said third region comprises a third layer of high-permeability particles dispersed in a natural or synthetic resin binder, and
said first and second layers are integral with said third layer.

40. The magnetic article of claim 39 wherein said layers are integrated by fusion.

41. The magnetic article of claim 39 wherein said layers are integrated by bonding.

42. A self-supporting magnetic article comprising
a body having a first magnetic surface and a second opposed magnetic surface,
said body having a first region adjacent to said first magnetic surface and containing magnetizable particles dispersed in a natural or synthetic resin binder,
a second region adjacent to said second magnetic surface and containing magnetizable particles dispersed in a natural or synthetic resin binder, and
a layer of metal interposed between said first region and said second region, said metal having a magnetic permeability greater than that of air.

43. The magnetic article of claim 42 wherein
said first region comprises a first layer of magnetic particles dispersed in a natural or synthetic resin binder,
said second region comprises a second layer of magnetic particles dispersed in a natural or synthetic resin binder, and
said first and second layers are bonded to said metal layer.

44. A method of preparing a magnetizable article comprising
1) preparing a first dispersion of magnetizable magnetic particles in a first extrudible binder;
2) preparing a second dispersion of high-permeability particles in a second extrudible binder, said high-permeability particles having a magnetic permeability greater than that of air; and
3) coextruding said dispersion of magnetizable magnetic particles and said dispersion of high-permeability particles to form an integrated article having a first region of preferential concentrations of said magnetizable particles adjacent to one surface of said article, a second region of preferential concentration of said magnetizable particles adjacent to a second surface of said article, and a third region of preferential concentration of said high-permeability particles between said first region and said second region,
with a gradient of concentration of at least one of said magnetizable particles and said high-permeability particles between said first and third regions and said second and third regions.

45. The method of claim 44 comprising the additional step of magnetizing at least a portion of said magnetizable particles in said magnetizable article.

46. A stock material for the preparation of magnetic articles comprising
a magnetizable web having a first major surface and a an second major surface
said web comprising a natural or synthetic resin binder having magnetizable particles and high-permeability particles dispersed therein,
said magnetizable particles being concentrated toward said first major surface and said high-permeability particles being concentrated toward said second major surface.

47. The stock material of claim 46 wherein at least some of said magnetizable particles are magnetized.

48. The stock material of claim 46 wherein said magnetizable particles in said web are magnetized to provide a pole spacing of from about 0.5 poles per inch to about 20 poles per inch.

49. A magnetizable article comprising
a magnetizable layer comprising magnetizable particles dispersed in a natural or synthetic resin binder, and
a high-permeability layer integrated with said magnetizable layer, said high-permeability layer comprising high-permeability particles dispersed in a natural or synthetic resin binder.
